(19) United States
(12) Patent Application Publication
(10) Pub. No.: US 2021/0292144 A1
(43) Pub. Date: Sep. 23, 2021

(54) PANEL MANIPULATION VEHICLES AND ASSEMBLIES

(71) Applicant: Global Bamboo Technologies, Inc., Windsor, CA (US)

(72) Inventors: Brenden Morton, Arcata, CA (US); Ross Huber, Redway, CA (US)

(21) Appl. No.: 17/203,556

(22) Filed: Mar. 16, 2021

Related U.S. Application Data
(60) Provisional application No. 62/990,753, filed on Mar. 17, 2020.

(51) Int. Cl. B66F 9/065; B62B 3/04; B62B 3/10; B66F 9/18; B66F 9/075; B66D 3/12

(52) U.S. Cl. CPC B66F 9/065; B62B 3/04; B66D 3/12; B66F 9/18; B66F 9/07554; B62B 3/108

(57) ABSTRACT

Panel manipulation assemblies and panel manipulation vehicles include a wrist assembly having at least two degrees of freedom, and a hand assembly coupled with the wrist assembly, the hand assembly having at least one degree of freedom independent of the wrist assembly. The hand assembly includes panel securement structure configured to securely hold a material panel.

### CROSS REFERENCE TO RELATED APPLICATIONS

This application claims the benefit of U.S. Provisional Patent Application No. 62/990,753, filed Mar. 17, 2020, the entirety of which is hereby incorporated by reference for all purposes.

### SUMMARY

The present disclosure provides panel manipulation vehicles and panel manipulation assemblies configured to facilitate to safe and precise movement and placement of material panels, such as panel products including but not limited to wood-bamboo hybrid panels, wood panels, structural insulated panels, and the like. The present disclosure further provides methods of using the same.

### BRIEF DESCRIPTION OF THE SEVERAL VIEWS OF THE DRAWINGS

The foregoing aspects and many of the attendant advantages of the claimed subject matter will become more readily appreciated by reference to the following detailed description, when taken in conjunction with the accompanying drawings and appendix, wherein:

FIG. 1 illustrates a panel manipulation vehicle in accordance with one representative embodiment of the present disclosure.

FIG. 2 illustrates the panel manipulation vehicle of FIG. 1, in accordance with one aspect of the present disclosure.

FIG. 3 illustrates a panel manipulation assembly and a portion of a mobility base, in accordance with one representative embodiment of the present disclosure.

FIG. 4 illustrates an aspect of the panel manipulation assembly of FIG. 3.

FIG. 5 illustrates another aspect of the panel manipulation assembly of FIG. 3.

FIG. 6 illustrates another aspect of the panel manipulation assembly of FIG. 3.

FIGS. 7A and 7B illustrate aspects of a panel manipulation vehicle, in accordance with one representative embodiment of the present disclosure.

FIGS. 8A and 8B illustrate other aspects of the panel manipulation vehicle of FIGS. 7A and 7B.

FIGS. 9A and 9B illustrate still other aspects of the panel manipulation vehicle of FIGS. 7A and 7B.

FIGS. 10A and 10B illustrate still other aspects of the panel manipulation vehicle of FIGS. 7A and 7B.

FIGS. 11A and 11B illustrate still other aspects of the panel manipulation vehicle of FIGS. 7A and 7B.

### DETAILED DESCRIPTION

Panel manipulation vehicles, panel manipulation assemblies, mobility bases, and methods provided herein enable the safe and precise movement and placement of material panels. Although the panel manipulation vehicles and panel manipulation assemblies are frequently described herein in the context of wood-bamboo hybrid panels to facilitate understanding, the inventive vehicles, assemblies, and methods are not limited to wood-bamboo hybrid panels, and may be utilized in connection with any material panel or panel product.

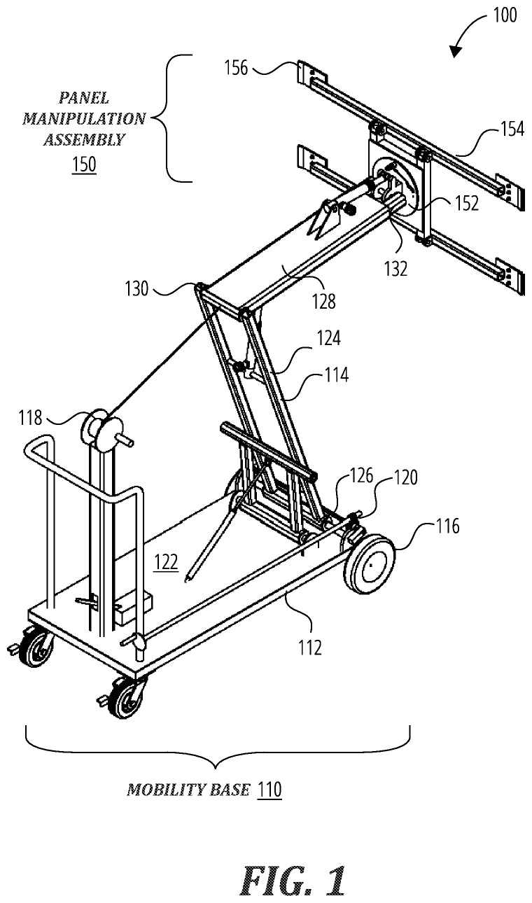

FIG. 1 shows one representative and non-limiting panel manipulation vehicle 100 that greatly facilitates the movement and placement of material panels, e.g., bamboo-wood hybrid panels, other wood panels, structural insulated panels, and the like. Advantageously, the panel manipulation vehicle 100 includes a number of features that increase the speed, accuracy, and safety with which a human operator can pick up, move, and position a material panel. Although described in the context of bamboo-wood hybrid panels in this disclosure, the inventive apparatuses and methods are not limited to bamboo-wood hybrid panels, or to wood panels even. Rather, the inventive apparatuses and methods may be utilized in connection with any material panel or panel product unless stated otherwise.

The panel manipulation vehicle 100 includes a mobility base 110 operatively coupled with a panel manipulation assembly 150, both of which are described below in detail. The inventive concepts of the present disclosure include panel manipulation vehicles 100, mobility bases 110 (independently), and panel manipulation assemblies 150 (independently).

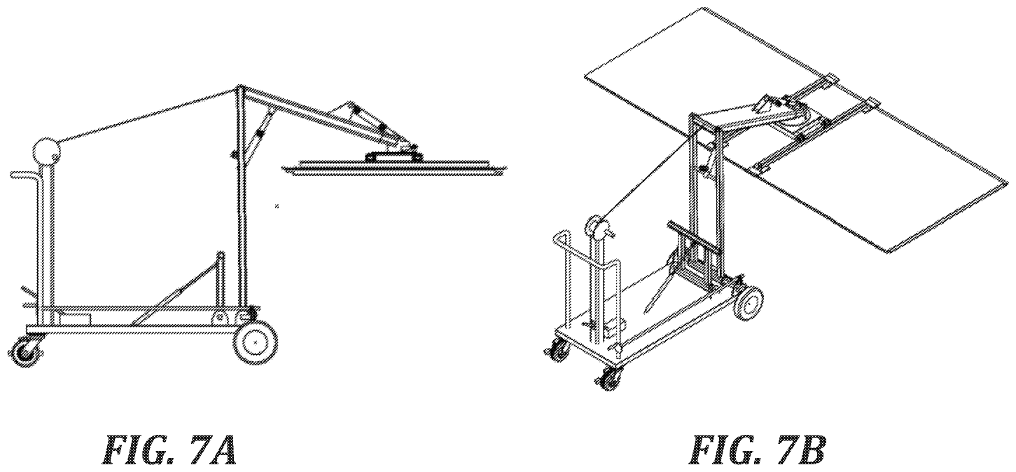

The mobility base 110 includes a mobile chassis 112 operatively coupled with an articulating hoist 114. The mobile chassis 112 is coupled to a plurality of wheels 116 to facilitate movement of the panel manipulation vehicle 100. In some embodiments, the mobile chassis 112 supports additional features, for example one or more force assist mechanisms 118 and/or a side shift mechanism 120 to regulate movement of the panel manipulation vehicle 100 between a first position and a second position (e.g., the positions shown in FIG. 7-FIG. 11). Representative force assist mechanisms 118 include active elements such as winches and actuators (e.g., hydraulic, pneumatic, or electric actuators), and passive elements (e.g., gas cylinders, springs, weights, and the like). Generally, the force assist mechanism 118 aids movement of the panel manipulation assembly 150 from a first position to a gravitationally higher second position. Generally, the side shift mechanism 120 enables side-to-side movement of the panel manipulation assembly 150 relative to the mobile chassis 112 in constant plane relative to the ground (e.g., back and forth along a front edge of mobility base 110. Representative side shift mechanisms 120 include active mechanisms such as actuators, drives, etc., and/or passive elements such as manual worm screws, rack and pinions mechanisms, and sliding tracks.

In some embodiments, the mobile chassis 112 supports one or more counterweights 122 or ballast configured to maintain a center of gravity of the panel manipulation vehicle 100 behind a front wheel 116 when the panel manipulation vehicle 100 manipulates a material panel. The location of the counterweight 122 may vary in different embodiments, and is not limited to the location shown in FIG. 1. For example, in some embodiments, the counterweight 122 is disposed toward a rear portion of the mobility base 110, such as near or on an operator station, e.g., on structure (for example, a post) that supports a force-assist mechanism such as a winch. In the illustrated embodiment, the mobility base 110 includes a plurality of wheels 116; in some embodiments, the mobility base 110 additionally or alternatively includes tracks, skids, and/or the like.

The articulating hoist 114 includes a first arm 124 connected to the mobile chassis 112 at a first pivot point 126, and a second arm 128 pivotably connected to the first arm 124 at a second pivot point 130. In some embodiments, the first arm 124 and/or the second arm 128 telescope to provides additional functionality. In some embodiments, the second arm 128 connects with a third arm 132 of the panel manipulation assembly 150, e.g., a third arm 132 that telescopes relative the second arm 128. In some embodiments, the articulating hoist 114 is part of the panel manipulation assembly 150, rather than the mobility base 110.

As described in detail below, the panel manipulation assembly 150 includes a wrist assembly 152 coupled to the articulating hoist 114, and a hand assembly 154 coupled with the wrist assembly 152. The hand assembly 154 includes panel securement structure 156 configured to securely hold a material panel, e.g., a relatively flat panel at least partially comprised of bamboo, wood, MDF, and/or other material. These features are described below in detail.

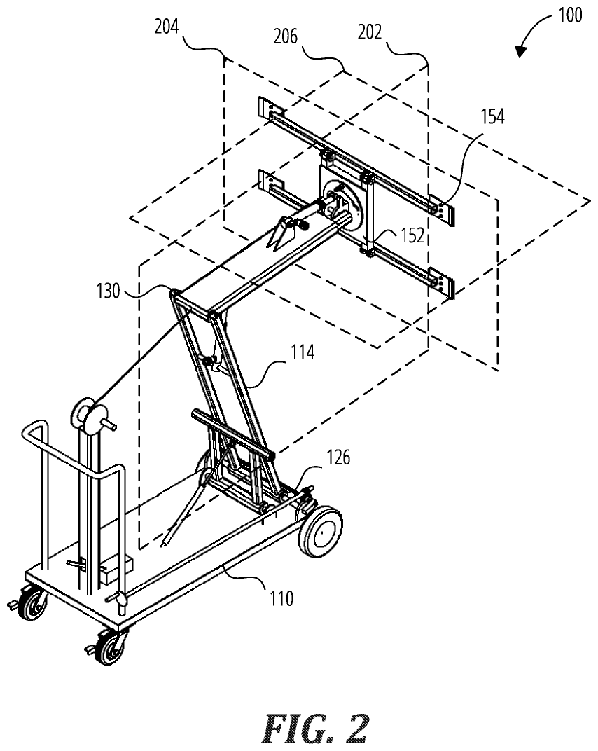

Referring to FIG. 2, panel manipulation vehicles 100 of the present disclosure are configured to move in at least three independent ways.

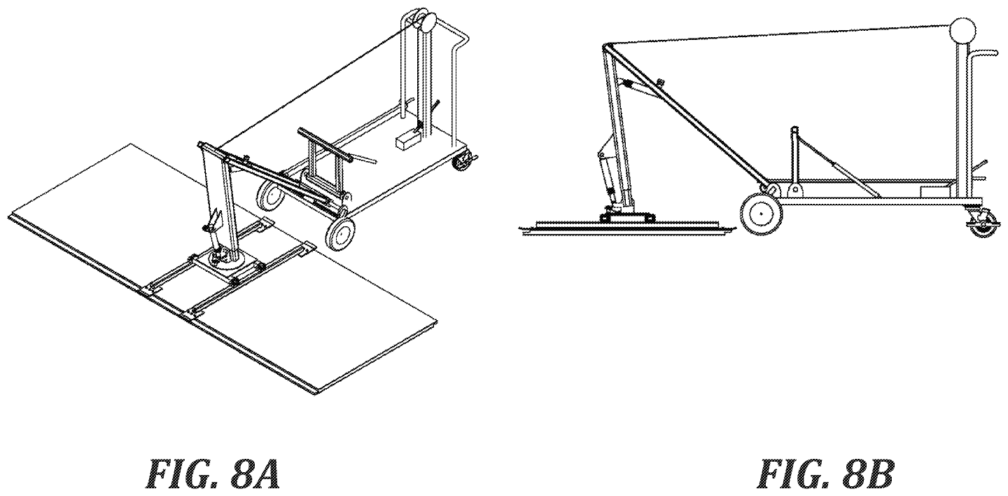

First, one or more elements of the panel manipulation vehicle 100 are configured to move in a first plane 202 (a vertical plane) relative to the mobility base 110. In the illustrated embodiment, the wrist assembly 152 is configured to pivot in the first plane 202 relative to the articulating hoist 114 (i.e., a first degree of freedom), e.g., by about −90 degrees to about 90 degrees relative to the “vertical” orientation shown. The articulating hoist 114 is also configured to independently pivot in the first plane 202 about the first pivot point 126 and the second pivot point 130. The ability of the one or more elements of the panel manipulation vehicle 100 to articulate at one, two, three, or more independent points within the first plane 202 advantageously enables the panel manipulation vehicle 100 to easily pick up a material panel, e.g., off a stack of panels (as shown in FIGS. 7A and 7B) or off the ground (as shown in FIGS. 8A and 8B).

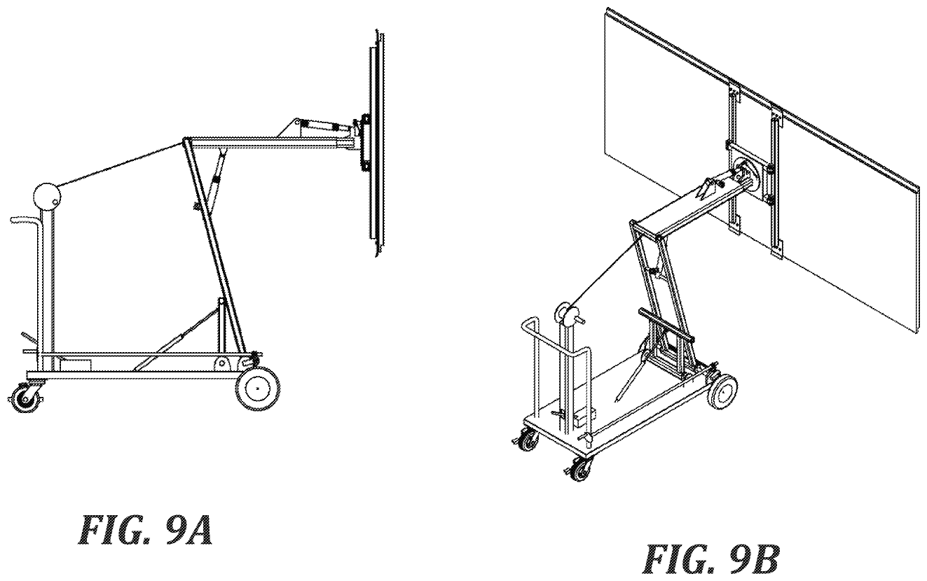

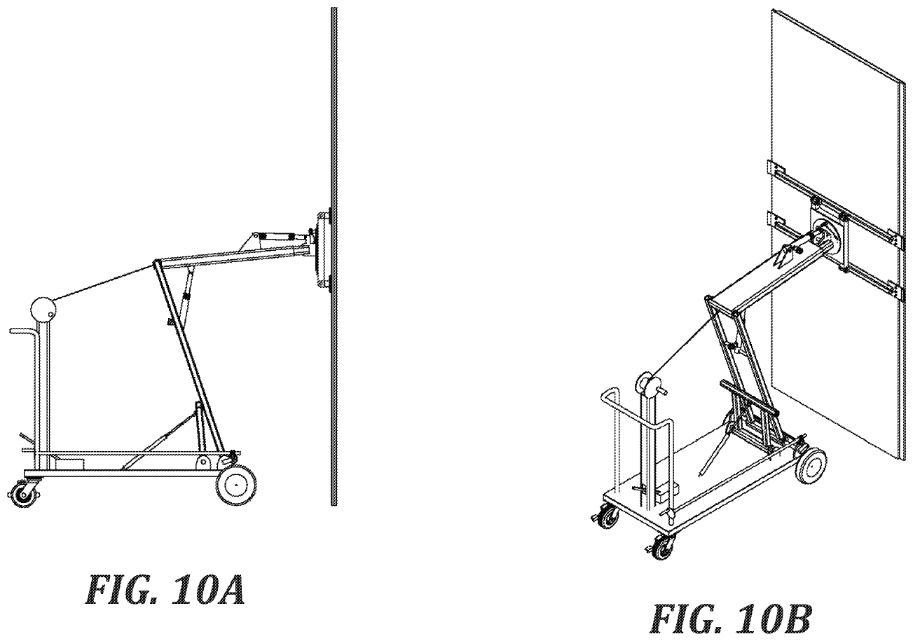

Second, one or more elements of the panel manipulation vehicle 100 are configured to rotate in a second plane 204 (another vertical plane) relative to the mobility base 110 or to the ground, e.g., by at least about −90 degrees to about 90 degrees relative to the “centered” orientation shown. In the illustrated embodiment, the panel manipulation assembly 150 is configured to rotate in the second plane 204 relative to the articulating hoist 114, because the hand assembly 154 rotates relative to the wrist assembly 152 as described below. In some embodiments, the articulating hoist 114 additionally or alternatively is configured to rotate in the second plane 204 relative to the mobile chassis 112. Advantageously, rotation within the second plane 204 enables the panel manipulation vehicle 100 to pick up a material panel in a horizontal orientation (as shown in FIGS. 7A-8B) and then to position the material panel in a vertical orientation (as shown in FIGS. 9A-10B). According to one representative method, the panel manipulation vehicle picks up a material panel in a horizontal orientation (see FIGS. 7A-7B), such as off a stack of similar material panels, and then positions the material panel in a vertical orientation, such as against a wall section (see FIGS. 10A-10B).

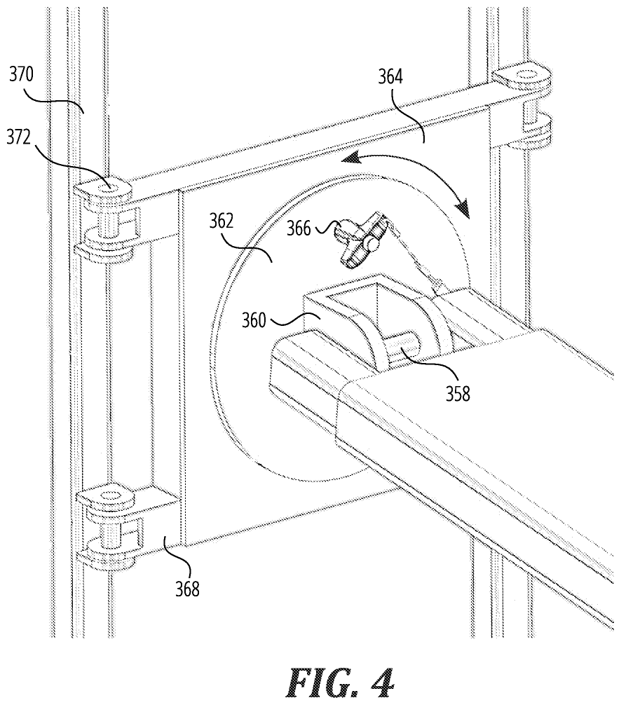

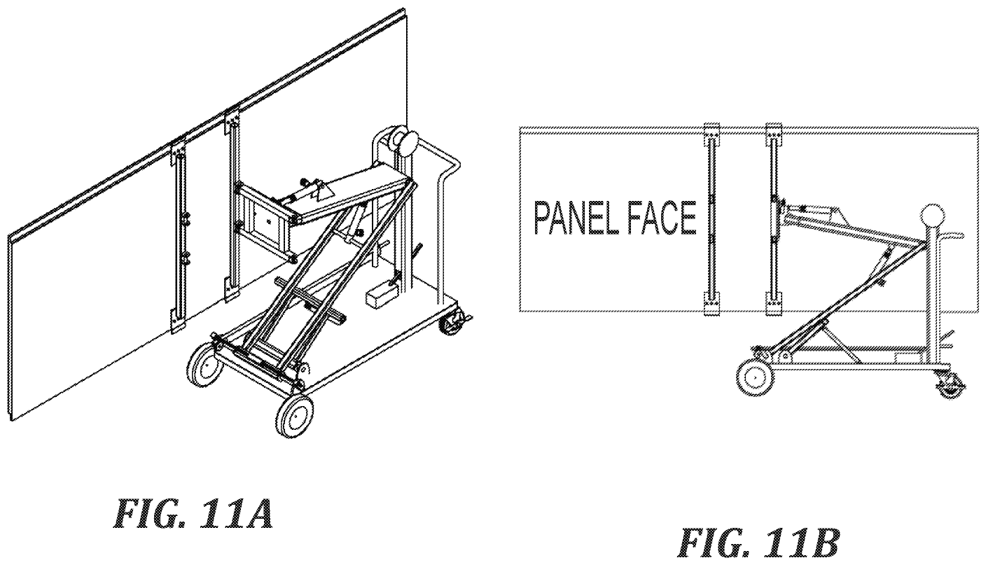

Third, one or more elements of the panel manipulation vehicle 100 are configured to rotate in a third plane 206 (a horizontal plane) relative to the ground, e.g., by about 90 degrees or more. In the illustrated embodiment, the panel manipulation assembly 150 is configured to pivot relative to the mobility base 110 in the third plane 206. In particular, the hand assembly 154 is configured to pivot in third plane 206 relative to the wrist assembly 152. See FIG. 4. In some embodiments, the panel manipulation assembly 150 (including the wrist assembly 152 and the hand assembly 154) is configured to pivot in the third plane 206 relative to the articulating hoist 114. In some embodiments, the articulating hoist 114 and the panel manipulation assembly 150 are configured to pivot in the third plane 206 relative to the mobile chassis 112. Advantageously, rotation within the third plane 206 enables the panel manipulation assembly 150 to hold a material panel substantially parallel to the direction of travel of the panel manipulation vehicle 100 (i.e., parallel to a side of the mobility base 110), as shown in FIGS. 11A and 11B. This orientation advantageously allows the panel manipulation vehicle 100 to traverse narrow passages while holding a material panel.

According to one representative method, the panel manipulation vehicle holds a material panel in a vertical orientation (see FIGS. 9A-9B). A portion of the panel manipulation vehicle is then pivoted such that the material panel is pivoted from a first vertical orientation relative to the mobile chassis (again, FIGS. 9A-9B), to a second vertical orientation relative to the mobile chassis, such that in the second vertical orientation, a panel face of the material panel is parallel with a side of the mobile chassis. (see FIGS. 11A-11B).

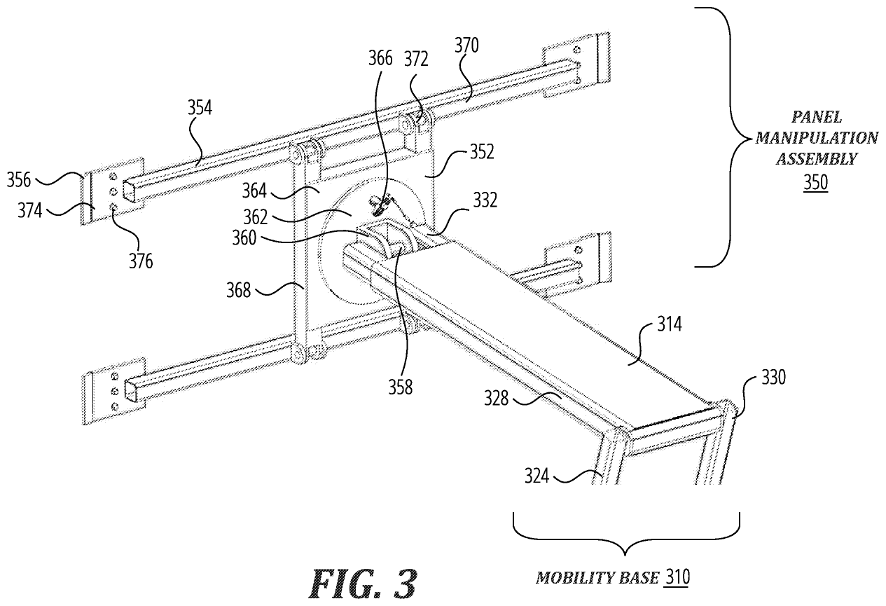

FIG. 3 shows details of one representative interconnection between an articulating hoist 314, a wrist assembly 352 and a hand assembly 354. In the illustrated embodiment, the interconnection pertains to an interconnection between a mobility base and a panel manipulation assembly because the articulating hoist 314 is part of the mobility base 310. However, the illustrated interconnection is equally applicable to other embodiments in which the articulating hoist 314 is part of the panel manipulation assembly 350, not the mobility base 310.

The articulating hoist 314 includes a first arm 324 pivotably coupled with a second arm 328 at a second pivot point 330, similar to the structure shown in FIG. 1.

A third arm 332 of the wrist assembly 352 telescopically connects with a second arm 328 of the articulating hoist 314. In some embodiments (as in FIG. 1), the third arm is part of the articulating hoist, rather than the hand panel manipulation assembly. In some embodiments, the wrist assembly 352 does not telescope relative to the articulating hoist 314.

The wrist assembly 352 includes a wrist pin 358 and a wrist bracket 360 that cooperatively enable the wrist assembly 352 to pivot relative to the mobility base 310 (e.g., in the second plane 204 of FIG. 2). In some embodiments, the wrist pin 358 is part of the wrist assembly 352; however, in some embodiments, the wrist pin 358 is part of the articulating hoist 314.

The wrist bracket 360 is fixed to a backing plate 362, e.g., via a weld, bolt, or other fixation means. In some embodiments, the backing plate 362 is part of the wrist assembly 352; however, in some embodiments, the backing plate 362 is part of the hand assembly 354. The wrist bracket 360 and the backing plate 362 pivotably couple with a pivot plate 364, e.g., via a bolt, hub, hinge, cam, or other rotatable coupling structure. Restated, the backing plate 362 and the pivot plate 364 are pivotably coupled such that the backing plate 362 and the pivot plate 364 can rotate relative to each other about coupling structure, i.e., rotate in the second plane 204 of FIG. 2. In some embodiments, the pivot plate 364 is part of the wrist assembly 352; however, in some embodiments, the pivot plate 364 is part of the hand assembly 354.

Comparing FIG. 3 with FIG. 4 (and also comparing FIGS. 9A-9B with FIGS. 10A-10B), it is evident how the backing plate 362 and the pivot plate 364 are configured to rotate relative to each other (see arrow in FIG. 4). In FIG. 3, the hand assembly 354 has a first orientation (i.e., a major brace 370 extends to the sides), whereas in FIG. 4, the hand assembly 354 has a second orientation (i.e., major brace 370 extends up and down). In both figures, the wrist bracket 360 and backing plate 362 remain stationary. Thus, the pivot plate 364 rotates relative to the backing plate 362 about the coupling structure.

Referring again to FIG. 3, the backing plate 362 is fitted with an optional rotation regulation mechanism 366 to prevent, slow, or otherwise regulate rotational movement between the backing plate 362 and the pivot plate 364. In the illustrated embodiment, the rotation regulation mechanism 366 includes a removable pin that extends through the backing plate 362 and the pivot plate 364 in order to lock rotational movement. In some embodiments, the rotation regulation mechanism 366 includes a screw- or cam-actuated friction mechanism to slow and/or prevent rotational movement.

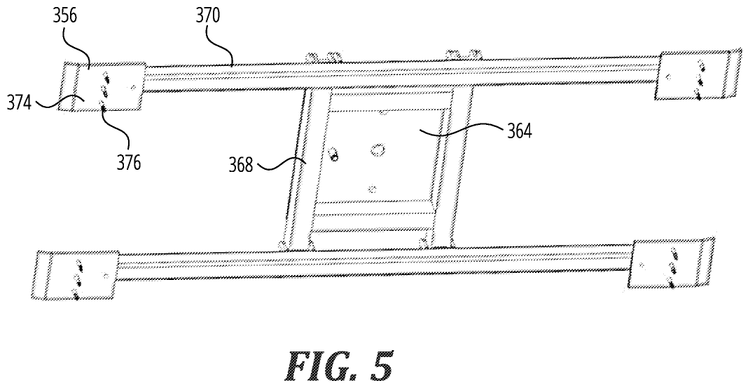

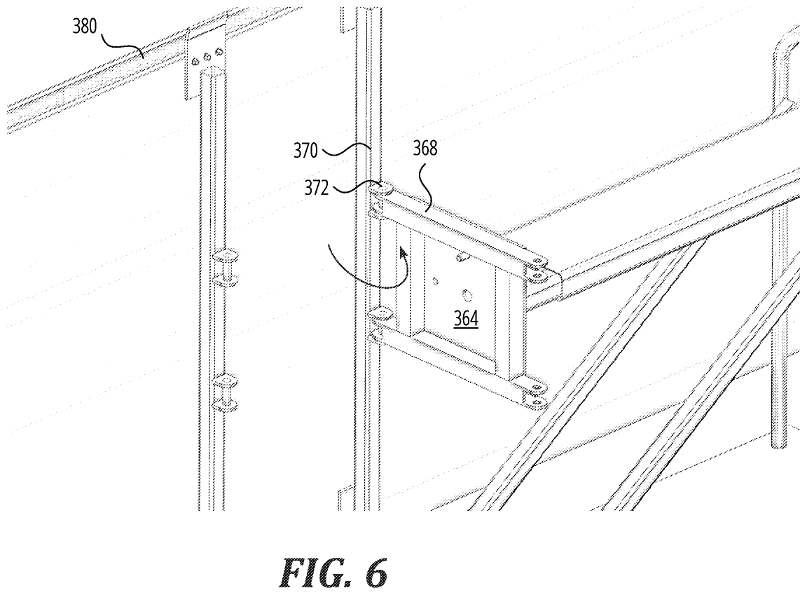

Referring to FIG. 3, along with FIG. 4, FIG. 5, and FIG. 6, details of the hand assembly 354 will now be described. The hand assembly 354 is generally configured to hold or “grip” a material panel, e.g., a panel at least partially comprised of bamboo, MDF, foam, sheetrock, glass, and/or other construction material. As such, elements of the hand assembly 354 are sized accordingly. See, for example, material panel 380 shown in FIG. 6.

In the illustrated embodiment, the hand assembly 354 includes the pivot plate 364 described above, at least one minor brace 368 coupled with the pivot plate 364, at least one major brace 370 hingeably coupled with at least one of the minor braces 368 by at least one hinge 372, and a plurality of panel securement structures 356. Advantageously, this enables the major brace 370 to pivot about the hinge 372 relative to the backing plate 364 and minor brace 368, which enables the panel manipulation vehicle to move a material panel between the vertical orientations shown in FIGS. 9A-9B and FIGS. 11A-11B.

The minor brace 368 is generally sized and configured such that when the major braces 370 pivot relative to the pivot plate 364 about the hinges 372 (as shown in FIG. 6), the material panel 380 is held along a side of the panel manipulation vehicle, as shown in FIG. 11. In this way, the panel manipulation assembly 350 enables the material panel 380 to be oriented in a direction substantially parallel to the direction of intended travel of the panel manipulation vehicle. Accordingly, the minor brace 368 is formed from a sturdy material such as tube steel or aluminum. Some embodiments do not have minor braces 368, and instead the major brace 370 hingeably connects directly to the pivot plate 364, which is sized such that when the major braces 370 pivot relative to the pivot plate 364 about the hinges 372 (as shown in FIG. 6), the material panel 380 is held along the side of the panel manipulation vehicle.

The major brace 370 is generally configured to span the width of the material panel 380, as shown in FIG. 6. Therefore, the major brace 370 generally has a length corresponding to the width (or shorter dimension) of the material panel 380, for example about 48 inches or another standard sheet size. In some embodiments, the major brace 370 has an adjustable length, for example one or more telescoping brace elements or the like, such that the major brace 370 can span a plurality of material panel sizes, which enables the panel manipulation assembly 350 to grasp a plurality of material panel sizes.

As shown in FIG. 6, the major brace 370 hingeably connects to the minor brace 368 via hinge 372 such that it pivots relative to the minor brace 368 and to the backing plate 362 (e.g., in the third plane 206 of FIG. 2). Accordingly, this enables the major brace 370 to pivot relative to the mobility base 310, such that the material panel 380 can be oriented along the side of the panel manipulation vehicle.

Referring to FIG. 3 and FIG. 5 together, each major brace 370 includes a panel securement structure 356 positioned at opposite ends thereof. The panel securement structures 356 are each configured to securely engage (e.g., grip, attach to, hold, or otherwise support) a material panel, independently and/or in connection with another of the panel securement structures 356. The illustrated embodiment includes a plurality of panel securement structures 356 to increase stability and safety. In some embodiments, the panel manipulation assembly 350 includes a single panel securement structure 356 that forms the sole attachment point of the material panel 380 to the panel manipulation assembly 350.

Referring to FIG. 3 and FIG. 5 still, in the illustrated embodiment, each panel securement structure 356 includes a hand bracket 374 having a plurality of lag bolts 376 extending therethrough. The number of lag bolts 376 is representative, and may be fewer or greater in different embodiments. Each lag bolt is configured to extend into (e.g., through) a body of the material panel 380 of FIG. 6 and to grip that panel with its teeth. This positive engagement between the 350 and the material panel 380 enables safe and stable rotation, pivoting, and movement of the material panel 380 by the panel manipulation vehicle. Further, by engaging the body of the material panel 380 rather than an edge thereof, such panel securement structure 356 enable the precise placement of the material panel 380 immediately adjacent and flush to another material panel. In some embodiments, the panel securement structure 356 includes a clamp, a tooth, and/or a finger configured to engage the material panel 380, such as an edge thereof, without damaging or otherwise compromising the appearance of the material panel 380.

FIGS. 7A-7B illustrate a panel manipulation vehicle as described above picking up a material panel in a horizontal orientation from a stack of similar material panels.

FIGS. 8A-8B illustrate a panel manipulation vehicle as described above picking up a material panel in a horizontal orientation from a ground surface.

FIGS. 9A-9B illustrate a panel manipulation vehicle as described above holding a material panel in a first vertical orientation relative to the mobile chassis.

FIGS. 10A-10B illustrate a panel manipulation vehicle as described above illustrate a panel manipulation vehicle as described above holding a material panel in a second vertical orientation relative to the mobile chassis.

FIGS. 11A-11B illustrate a panel manipulation vehicle as described above illustrate a panel manipulation vehicle as described above holding a material panel in a third vertical orientation relative to the mobile chassis, such that a panel face of the material panel is parallel to a side of the mobile chassis.

The present application may reference quantities and numbers. Unless specifically stated, such quantities and numbers are not to be considered restrictive, but representative of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” “substantially,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

The detailed description set forth above in connection with the appended drawings, where like numerals reference like elements, are intended as a description of various representative embodiments of the present disclosure and are not intended to represent the only embodiments. Each embodiment described in this disclosure is provided as an example or illustration and should not be construed as preferred or advantageous over other embodiments. The illustrative examples provided herein are not intended to be exhaustive or to limit the disclosure to the precise forms disclosed. Similarly, any steps described herein may be interchangeable or combinable with other steps, or combinations of steps, in order to achieve the same or substantially similar result. Generally, the embodiments disclosed herein are non-limiting, and the inventors contemplate that other embodiments within the scope of this disclosure may include combinations of structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

What is claimed is:

1. A panel manipulation assembly couplable to a panel manipulation vehicle and configured to selectively hold a material panel, the panel manipulation assembly comprising:
a wrist assembly comprising a wrist bracket and a pivot plate, wherein the wrist bracket is configured to pivot relative to a mobility base of the panel manipulation vehicle, and wherein the pivot plate pivots relative to the wrist bracket; and
a hand assembly coupled with the wrist assembly, wherein the hand assembly comprises a minor brace pivotably coupled to a major brace, and panel securement structure disposed on the major brace and configured to secure to the material panel.

2. The panel manipulation assembly of claim 1, wherein the wrist assembly further comprises a wrist pin couplable with the wrist bracket.

3. The panel manipulation assembly of claim 1, wherein the wrist assembly comprises a rotation regulation mechanism configured to regulate rotation between the wrist bracket and the pivot plate.

4. The panel manipulation assembly of claim 2, wherein the wrist assembly comprises an arm pivotably connected to the wrist bracket via the wrist pin.

5. The panel manipulation assembly of claim 3, wherein the major brace has an adjustable length.

6. The panel manipulation assembly of claim 3, wherein the panel securement structure is configured to secure to an edge of the material panel.

7. The panel manipulation assembly of claim 5, wherein the panel securement structure is selected from the group consisting of: a bolt, a clamp, a tooth, and a finger.

8. A panel manipulation vehicle configured to selectively hold a material panel, comprising:
a mobility base comprising a mobile chassis; and
a panel manipulation assembly couplable with the mobility base, comprising:
a wrist assembly comprising a wrist bracket and a pivot plate, wherein the wrist bracket is configured to pivot relative to a mobility base, and wherein the pivot plate pivots relative to the wrist bracket; and
a hand assembly coupled with the wrist assembly, wherein the hand assembly comprises a minor brace pivotably coupled to a major brace, and panel securement structure disposed on the major brace and configured to secure to the material panel.

9. The panel manipulation vehicle of claim 8, wherein the mobility base comprises an articulating hoist couplable to the panel manipulation assembly and to the mobile chassis.

10. The panel manipulation vehicle of claim 9, further comprising a force assist mechanism that aids movement of the panel manipulation assembly from a first position to a gravitationally higher second position.

11. The panel manipulation vehicle of claim 8, further comprising a counterweight disposed upon the mobile chassis and configured to maintain a combined center of gravity of the panel manipulation vehicle and the material panel behind a front wheel of the mobile chassis.

12. The panel manipulation vehicle of claim 8, further comprising a side shift mechanism that shifts the panel manipulation assembly along a front edge of the mobile chassis in a constant plane relative to a ground surface.
